(19) United States
(12) Patent Application Publication
(10) Pub. No.: US 2021/0055093 A1
(43) Pub. Date: Feb. 25, 2021

(54) PIPE DIMENSIONAL MEASUREMENT TOOL

(71) Applicant: NATIONAL OILWELL VARCO, L.P., Houston, TX (US)

(72) Inventors: Kevin D. Logan, Humble, TX (US); Clive C. Lam, Tomball, TX (US)

(21) Appl. No.: 16/545,496

(22) Filed: Aug. 20, 2019

(51) Int. Cl. G01B 5/08; G01B 3/20

(52) U.S. Cl. CPC G01B 5/08; G01B 3/205

(57) ABSTRACT

A tool for determining variations in outer diameter of a pipe. The tool may have a pair of contact arms configured for engaging with opposing sides of a pipe. The contact arms may be biased toward one another, and at least one of the arms may be configured to slide toward and away from the other. As the contact arms are moved along an outer surface of a pipe, a distance between the arms may change in response to variations in outer diameter of the pipe. A plunger gauge may be arranged on one of the contact arms with its plunger directed toward the other arm. The plunger may extend or depress in response to a decreased or increased distance between the contact arms. An alignment shoe may align the contact arms with at least X and Z axes of the pipe so as to help ensure accurate pipe measurements.

### FIELD OF THE INVENTION

The present disclosure relates to dimensional measurement tools. In particular, the present disclosure relates to a tool for determining outside diameter profile of a pipe or conduit. More particularly, the present disclosure relates to a tool for measuring an outer diameter of a pipe or conduit at locations around a circumference of the pipe or conduit using a pair of contact arms and a plunger gauge, the tool having an alignment shoe for aligning the contact arms with respect to one or more axes of the pipe, and the tool having a processor for collecting, transmitting, and/or analyzing data.

### BACKGROUND OF THE INVENTION

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

In many applications, variations in dimensions or a pipe or conduit may be problematic. For example, a drilling tool may extend into the earth by threadedly connecting stands of drill pipe together to form a drill string. The quality of the drill pipe, such as the consistency of the shape (e.g., outer diameter) of the drill pipe, may affect drilling operations. Variations in the shape of the drill pipe may affect, for example, rotation of the drill pipe during operation which may also affect operation of the drilling tool and/or drill bit.

Techniques have been developed for evaluating dimensional variation of drill pipe and/or other pipes or conduits. Inspections may include, for example, using handheld micrometers or calipers for spot measurements. However, such mechanisms may be difficult to maneuver and may yield inaccurate readings. Additionally, micrometers or calipers may not be suitable for checking outside diameter across an entire outer surface of the pipe. Other techniques may include laser devices. However, such devices may be relatively expensive, may lack portability, and/or may not be suitable for obtaining outside diameter profile measurements across an entire length of the pipe.

### BRIEF SUMMARY OF THE INVENTION

The following presents a simplified summary of one or more embodiments of the present disclosure in order to provide a basic understanding of such embodiments. This summary is not an extensive overview of all contemplated embodiments and is intended to neither identify key or critical elements of all embodiments, nor delineate the scope of any or all embodiments.

The present disclosure, in one or more embodiments, relates to a measurement tool for measuring an outer diameter of a pipe, the tool having a pair of contact arms configured to receive the pipe therebetween, each contact arm having a contact surface for engaging with an outer surface of the pipe. The measurement tool may additionally have a plunger gauge arranged on a first arm of the pair of contact arms, the plunger gauge having a plunger directed to extend toward a second of the pair of contact arms. In some embodiments, the measurement tool may have an alignment shoe having a surface configured to engage with the outer surface of the pipe, the alignment shoe configured to stabilize a position of the contact arms with respect to the pipe. In some embodiments, the measurement tool may have a gauge arm arranged on the second arm of the pair of contact arms, the gauge arm having a plunger engaging portion configured to engage with the plunger. The contact arms may extend from a track arm, and at least one of the contact arms may slidingly engage the track arm. In some embodiments, the alignment shoe may be configured to engage with the track arm. The contact arms may be biased toward one another. The gauge arm may extend between the contact arms with an adjustable length in some embodiments. Moreover, the alignment shoe may be configured to align the tool with an X-axis of the pipe and a Z-axis of the pipe. The plunger gauge may be configured to measure a distance of up to 1 inch. The contact surfaces of each of the contact arms may have a thickness of at least 0.25 inches or at least 0.5 inches.

The present disclosure, in one or more embodiments, additionally relates to a method of determining variation in an outer diameter of a pipe. The method may include obtaining a measurement tool having a pair of contact arms configured to receive the pipe therebetween and a plunger gauge arranged on a first arm of the pair of contact arms. The method may additionally include calibrating the tool. Calibrating the tool may include positioning a calibration standard between the two contact arms, the calibration standard having a known diameter or width, and adjusting the tool such that a plunger of the plunger gauge is extended to approximately half a full extension length of the plunger. The method may additionally include arranging the pipe between the two contact arms, together with an alignment shoe configured to align the tool. The alignment shoe may have a radiused surface sized to engage with an outer surface of the pipe. The method may further include moving the pipe and/or the measurement tool to obtain a plurality of measurements along the outer surface of the pipe. In some embodiments, a distance between the contact arms may be configured to increase and decrease in response to variation in the outer diameter of the pipe. Moreover, the contact arms may be biased toward one another. The plunger of the plunger gauge may be configured to extend and retract in response to variation in the outer diameter of the pipe. In some embodiments, calibrating the measurement tool may additionally include zeroing the plunger gauge. The tool may further include a gauge arm arranged on a second arm of the pair of contact arms and extending toward the first arm. Adjusting the tool may include adjusting a position of the gauge arm. In some embodiments, the alignment shoe may be configured to align the tool with an X-axis and a Z-axis of the pipe.

The present disclose, in one or more embodiments, additionally relates to a measurement tool for measuring outer diameters of pipes having a range of outer diameter sizes. The tool may include a pair of contact arms configured to receive a pipe therebetween, each contact arm having a contact surface for engaging with an outer surface of the pipe. The tool may additionally have a plunger gauge arranged on a first arm of the pair of contact arms, the plunger gauge having a plunger directed to extend toward a second arm of the pair of contact arms. The tool may have a plurality of interchangeable alignment shoes, each shoe having a radiused surface sized to engage with the outer surface of a pipe having a corresponding outer diameter size. The alignment shoes may each be configured to stabilize a position of the contact arms with respect to a pipe. The alignment shoes may additionally be configured to align the tool with an X-axis and a Z-axis of the pipe.

The present disclosure, in one or more embodiments, additionally relates to a system for measuring an outer diameter of a pipe. The system may include a measurement tool, a processor in electronic communication with the measurement tool and configured to receive measurement data therefrom, and a user interface configured to display the measurement data. In some embodiments, the measurement tool may include a pair of contact arms configured to receive a pipe therebetween, each contact arm having a contact surface for engaging with an outer surface of the pipe. The tool may additionally have a plunger gauge arranged on a first arm of the pair of contact arms, the plunger gauge having a plunger directed to extend toward a second of the pair of contact arms. In some embodiments, the measurement data may include one or more plunger gauge readings, and the processor may be further configured to convert the one or more plunger gauge readings into one or more diameter measurements based on a stored calibration standard. In some embodiments, the processor may be configured to perform one or more statistical analyses of the measurement data. The user interface may be configured to display the one or more statistical analyses. Moreover, in some embodiments, the system may include a database for storing the measurement data.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a perspective view of a dimensional measurement tool of the present disclosure, according to one or more embodiments.

FIG. 2 is a side view diagram of an alignment shoe of the present disclosure arranged on a pipe, according to one or more embodiments.

FIG. 3 is a front view diagram of a dimensional measurement tool of the present disclosure arranged on a pipe, according to one or more embodiments.

FIG. 4 is a front view of another dimensional measurement tool of the present disclosure, according to one or more embodiments.

FIG. 5 is a front view of the dimension measurement tool of FIG. 2 in use, according to one or more embodiments.

FIG. 6 is a flow diagram of a method of the present disclosure, according to one or more embodiments.

FIG. 7 is a diagram of a dimensional measurement system of the present disclosure, according to one or more embodiments.

FIG. 8 is a screenshot of a user interface of the present disclosure, according to one or more embodiments.

FIG. 9 is a block diagram of another system of the present disclosure, according to one or more embodiments.

### DETAILED DESCRIPTION

The present disclosure relates to a tool for determining variations in the outer diameter measurements of a pipe, conduit, tube, pole, or other cylindrical shaped element. In particular, the present disclosure relates to a handheld tool having a pair of contact arms configured for engaging with opposing sides of a pipe so as to obtain a measurement indicative of diameter of the pipe. The contact arms may be biased toward one another, and at least one of the contact arms may be configured to slide toward and away from the other contact arm. As the contact arms are moved along an outer surface of a pipe, a distance between the contact arms may change in response to variations in outer diameter of the pipe. The tool may additionally have a plunger gauge arranged on one of the two contact arms with its plunger directed toward the other of the two contact arms. The plunger may be configured to extend or depress in response to a decreased or increased distance between the contact arms. Moreover, an alignment shoe may have a radiused surface configured to engage with an outer surface of the pipe, and may be configured to align the contact arms with at least X and Z axes of the pipe so as to help ensure accurate pipe measurements.

Turning now to FIG. 1, a dimensional measurement tool 100 of the present disclosure is shown, according to one or more embodiments. The tool 100 is shown engaging a pipe 101. The dimensional measurement tool 100 may be configured for measuring an outside diameter profile of a pipe or conduit. In particular, the tool 100 may be configured for measuring dimensional variation in pipe diameter. The tool 100 may be sized for to accommodate up to a maximum pipe diameter of 10 inches, 12 inches, 18 inches, 24 inches, or a different maximum pipe diameter. The tool 100 may have a pair of contact arms 102, which may each be arranged on a track arm 104. The tool 100 may have a gauge arm 106 and plunger gauge 108, each arranged on opposing ones of the arms 102. The tool 100 may additionally have an alignment shoe 110.

The two contact arms 102 may be configured for engaging with an outer surface of a pipe such that an outer diameter of the pipe may be measured between the two contact arms. Each contact arm 102 may have a generally flattened or planar shape. Each arm 102 may have a length sized to be at least half a diameter of a maximum measurable pipe diameter. That is, the arms 102 may have a length long enough such that, when arranged on a pipe for measuring, the arms may each extend down to opposing sides of a centerline of the pipe cross section. Each contact arm 102 may further have a contact surface 103 arranged along an edge thereof, configured for engaging with the pipe, and extending generally perpendicularly from the contact arm 102. For each arm 102, the contact surface 103 may have a thickness perpendicular to the length of the arm. The thickness of each contact surface 103 may be between approximately 0.1 inches and approximately 2 inches, or between approximately 0.2 inches and approximately 1 inch. In some embodiments, each contact surface may have a thickness of at least 0.1, at least 0.2, at least 0.3, at least 0.4, at least 0.5, at least 0.6, at least 0.7, at least 0.8, at least 0.9, or at least 1 inch. In other embodiments, the contact surface 103 may each have any other suitable thickness. The thickness may be selected to be large enough to help position the contact arms 102 perpendicularly to the pipe wall so as to resist measurements that are taken at an angle other than 90 degrees to the longitudinal centerline of the pipe. Each contact arm 102 may have any suitable shape, which may be a planar shape. For example, the contact arms 102 may each have a rectangular, triangular, or polygonal planar shape. In some embodiments, a thickness of the contact surface 103 may be equal to a thickness of the contact arm 102. Additionally, the contact surface 103 may have a length equal to a length of the contact arm 102 in some embodiments. However, in other embodiments, the contact surface 103 may have a thickness and length different than that of a remaining portion of the contact arm 102

The two contact arms 102 may be arranged on a track arm 104. The track arm may be an elongate member configured to slidingly or rollably engage with one or both contact arms 102. For example, the elongate arm 104 may have a track arranged along a surface thereof, the track having a groove or recess configured for engaging with a corresponding track engaging component on one or both contact arms 102. The track arm 104 may have a length defined along its longitudinal axis. The track arm 104 length may be sized to allow a pipe with a maximum measurable pipe diameter between the two contact surfaces 103. For example, where the tool 100 is configured to measurable pipe diameter is 18 inches, the track arm 104 may have a length equal to 18 inches, plus a width of the two contact arms 102. In some embodiments, the track arm 104 may have a scale or gauge printed thereon or affixed thereto to indicate a distance between the two contact arms.

Each of the contact arms 102 may extend from the track arm 104. The contact arms 102 may engage with the track arm 104 at a location along a length of each of the contact arms 102 that is near an end thereof. One or both contact arms 102 may be configured to slide along the track arm 104, parallel with a longitudinal axis of the track arm. In some embodiments, both contact arms 102. may slidingly or rollably engage with the track arm 104. In other embodiments, one contact arm 102 may be fixedly coupled to the track arm 104, while the second contact arm may be free to slide or roll along the track arm. Movement of one or both contact arms 102 may provide for increasing or decreasing a distance between the two contact surfaces 103 of the contact arms 102. In some embodiments, the contact arms 102 may be pulled toward one another by one or more springs, such that the contact arms may be biased toward one another. In a relaxed state, the contact arms 102 may be pulled together with contact surfaces 103 nearly meeting one another, or in some cases meeting.

As indicated above, a gauge arm 106 and plunger gauge 108 may be arranged on opposing ones of the contact arms 102. The plunger gauge 108 may have an extendable plunger and a gauge configured to measure changes in plunger depth or extension. The plunger gauge 108 may be configured to measure up to a maximum length (i.e. a maximum extension of the plunger) of 0.5 inches, 1 inch, 1.5 inches, 2 inches, or another suitable length. The plunger gauge 108 may provide a digital display or an analog dial. The plunger gauge 108 may be configured to measure in increments as small as 1/1000, 1/100, or 1/10 of an inch in some embodiments. The gauge 108 may be fixed to one of the contact arms 102 and arranged with its plunger extending toward the other contact arm. In particular, the plunger gauge 108 may be arranged on a contact arm 102 with its plunger directed to extend in a direction perpendicular to the contact surface 103 of the arm.

The gauge arm 106 may be fixedly coupled to a contact arm 102. that opposes the contact arm having the plunger gauge 108. The gauge arm 106 may be configured to depress or extend the plunger of the plunger gauge 108 in response to variations in an outer diameter of a pipe. The gauge arm 106 may have a length extending from the contact arm 102 to which it is coupled and toward the opposing contact arm. The gauge arm 106 may have any suitable length, and in some embodiments, may have a length similar to a maximum diameter measurable pipe outer diameter of the tool 100. For example, if the tool 100 is configured to measure a pipe of up to 18 inches, the gauge arm 106 may have a length of at least 16 inches or at least 18 inches. In some embodiments, the gauge arm 106 may have a coupling portion 112 and a plunger engaging portion 114.

The coupling portion 112 may couple the gauge arm 106 to a contact arm 102 at an end of the contact arm. A position of the gauge arm 106 may be adjustable with respect to the contact arm 102 to which it is coupled. In particular, a position of the gauge arm 106 may be adjustable such that its extension between the two contact arms 102 may be shortened or lengthened. For example, the coupling portion 112 of the gauge arm 106 may couple to the contact arm 102 with one or more screws or bolts arranged through a track or elongated opening of the gauge arm and/or contact arm. In other embodiments, other adjustment means may be used to adjust a position of the gauge arm 106 with respect to the contact arm 102. In still other embodiments, an extension of the gauge arm 106 between the contact arms 102 may be adjusted without adjusting a position of the gauge arm on the contact arm to which it is coupled. For example, the gauge arm 106 may be collapsible or may telescope, such that the gauge arm may be extended or collapsed as desired.

The plunger engaging portion 114 may be arranged at an end of the gauge arm 106 and may extend from the coupling portion 112. The plunger engaging portion 114 may provide a plunger engaging surface at an end of the gauge arm 106, the plunger engaging surface sized and configured to engage with the plunger of the plunger gauge 108. In some embodiments, the plunger engaging portion 114 may couple to the plunger of the gauge 108. In this way, as the contact arm 102 slides along the track arm 104 toward and away from the opposing contact arm 102, the coupled gauge arm 106 may also move toward and away from the opposing contact arm, and the plunger engaging portion 114 coupled to the plunger of the gauge 108 may compress and extend the plunger.

In some embodiments, the coupling portion 112 and plunger engaging portion 114 of the gauge arm 106 may be formed by two arms of an L-shaped bracket, as shown for example in FIG. 1, with two planar components coupled together at a 90-degree angle. In other embodiments, gauge arm 106 may be or include a rectangular, cylindrical, or other elongate block or member with a first end providing the coupling portion 112 and a second end providing the plunger engaging portion 114. In still other embodiments, the gauge arm 106 may have any other suitable configuration.

The tool 100 may additionally have an alignment shoe 110 configured for aligning the tool with a pipe 101. The alignment shoe 110 may be sized and configured to be arranged between the two contact arms 102 as the contact arms engage with an outer diameter of a pipe 101. The alignment shoe 110 may additionally be configured to engage with an outer diameter of the pipe 101 at a location on the pipe radially between where the contact arms 102 engage with the pipe. In some embodiments, the alignment shoe 110 may have a radiused surface 116 defined by a radius equal, or similar, to that of an outer surface of a pipe 101 to be measured. In other embodiments, the surface 116 may include an inverted v-shape so as to accommodate a range of pipe sizes while still providing alignment with a longitudinal axis of the pipe. In this way, it is to be appreciated that the alignment shoe 110 may be sized for a particular pipe size or range of pipe sizes. In still other embodiments, the alignment shoe 110 may have another angled surface or a flattened surface configured to engage with an outer surface of the pipe. The alignment shoe 110 may additionally be configured to engage with, or couple to, the track arm 104, a contact arm 102, and/or another portion of the tool 100. For example, the alignment shoe 110 may be configured to be arranged between the pipe 101 and the track arm 110 and may either couple to the track arm or may have a recess or other mechanism for engaging with the track arm. In other embodiments, the alignment shoe 110 may engage with, or couple to, one of the contact arms.

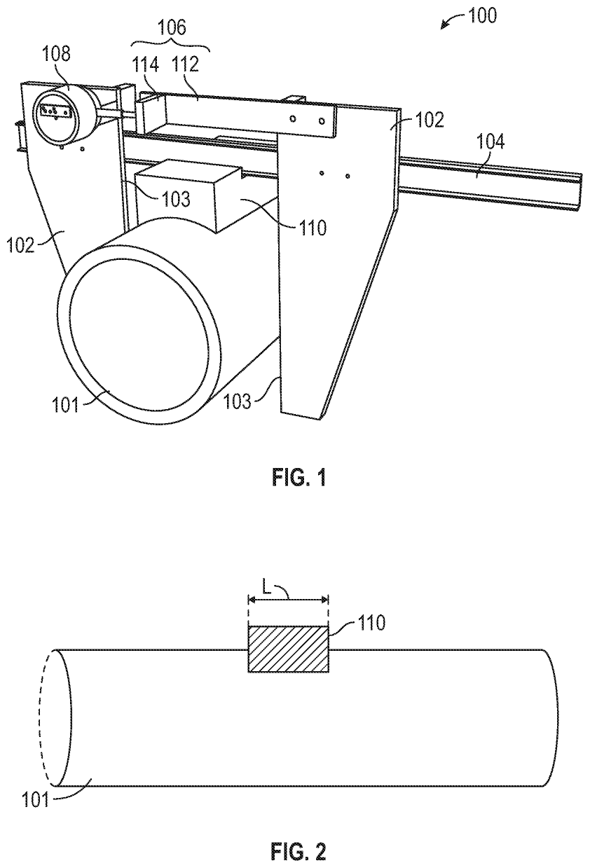

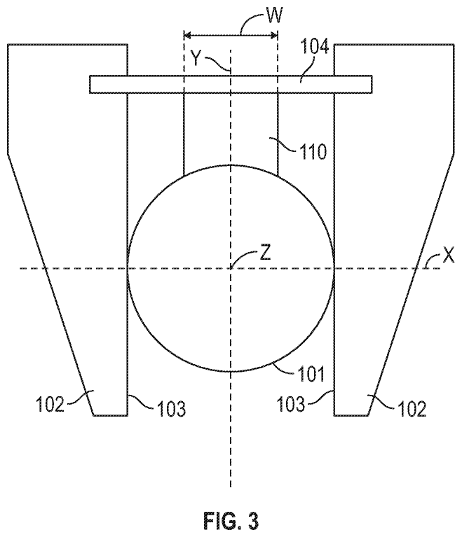

In some embodiments, the alignment shoe 110 may have a generally rectangular prism shape with the radiused or v-shaped surface 116 defined on one of six sides. As shown in FIG. 2, the alignment shoe 110 may have a length L, which may be a longest dimension of the shoe, configured to be axially aligned with a pipe 101. The alignment shoe 110 may have any suitable length configured to axially stabilize and/or sufficiently align the shoe with the pipe 101. As shown in FIG. 3, the alignment shoe 110 may have a width W, perpendicular to the length and sized to further help stabilize a position of the shoe on the pipe 101, For example, the width, W, may be sufficient such that the surface 116 may reach at least somewhat downward along the sides of the pipe. In some embodiments, the shoe 110 may have a width equal to, or smaller than, a diameter of the pipe 101.

As may be further appreciated with respect to FIG. 3, the alignment shoe 110 may be configured to stabilize a position of the tool 100 with respect to the pipe 101. In this way, the alignment shoe 110 may help to ensure more accurate outer diameter measurements of the pipe 101, In particular, the alignment shoe 110 may ensure that the contact arms 102. are perpendicular to a Z-axis, defined along, or parallel to, a longitudinal axis of the pipe 101. That is, the alignment shoe may “square up” the contact arms 102 with the pipe. Correspondingly, the alignment shoe 110 may additionally ensure alignment of the contact arms 102 along an X-axis, which may be defined to bisect the pipe 101 cross section and which may extend through contact points on the pipe where contact surfaces 103 engage with the pipe to measure outer diameter. In some embodiments, the alignment shoe 110 may additionally help to ensure alignment of the contact arms 102, or another portion of the tool 100, along a Y-axis, which may be defined as perpendicular to each of the X and Z axes, and which may be centrally arranged between the two contact arms.

The alignment shoe 110 may be readily removable or replaceable in some embodiments. As described above, in some embodiments, an alignment shoe 110 may be sized for a particular outer diameter size or a particular range of outer diameter sizes. Thus, to accommodate different pipes, different alignment shoes 110 may be used with the tool 100. The alignment shoe 110 may couple to the track arm 104, a contact arm 102, or another suitable component of the tool 100. The alignment shoe 110 may couple to the tool using one or more bolts or screws, such that the bolts or screws may be loosened to allow decoupling of the alignment shoe as desired. In other embodiments, however, the alignment shoe 110 may be permanently coupled to the tool 100 by welding, an adhesive, and/or another suitable coupling means.

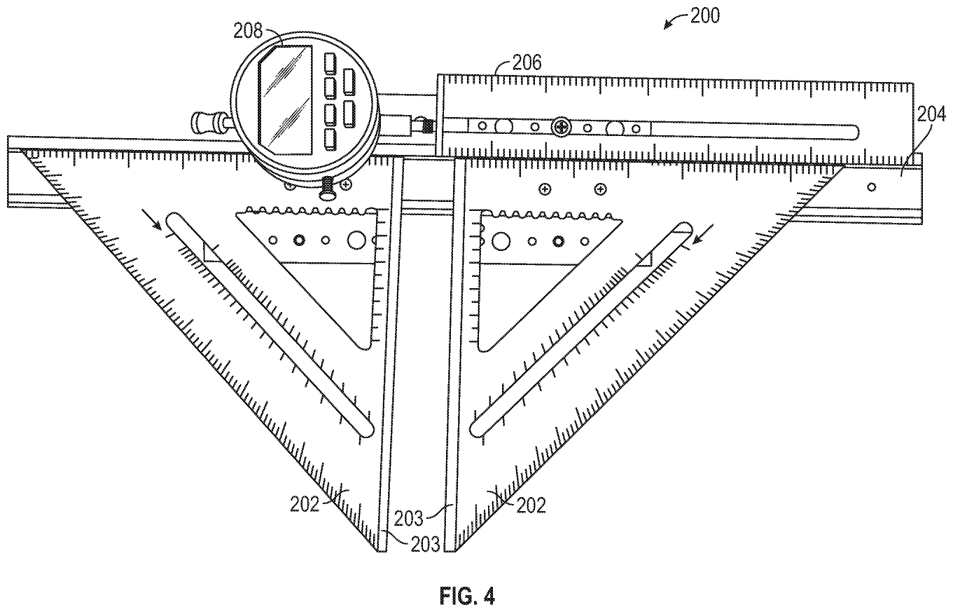

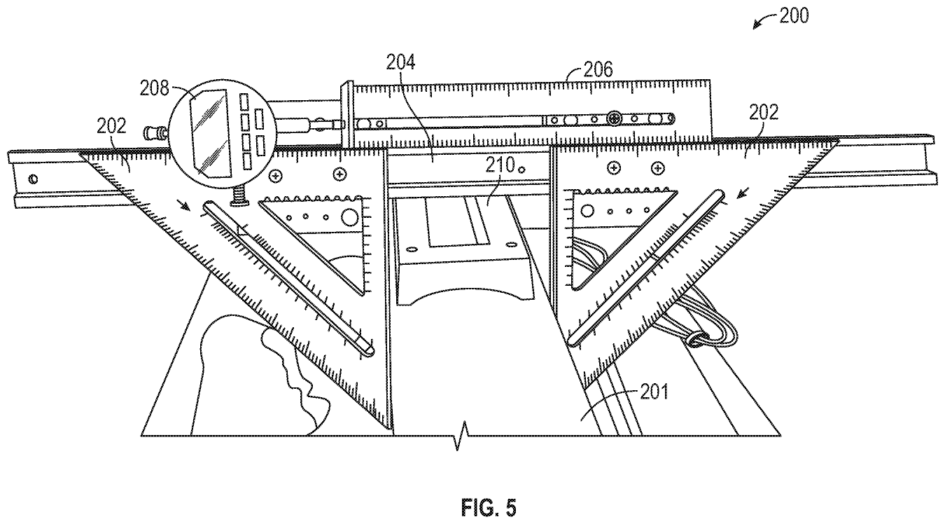

FIGS. 4 and 5 show another embodiment of a dimensional measurement tool 200 of the present disclosure. The tool 200 may have a pair of contact arms 202 extending from a track arm 104. The tool 200 may additionally have a plunger gauge 208 and gauge arm 206 arranged on, coupled to, or extending from different ones of the two contact arms 202. The plunger of the gauge 208 may be directed toward the gauge arm 206, and the gauge arm may be configured to extend and retract the plunger as the contact arms 202 move apart and toward one another. As shown in FIG. 5, the tool 200 may have an alignment shoe 210 configured to align the contact arms 202 with respect to a pipe 201.

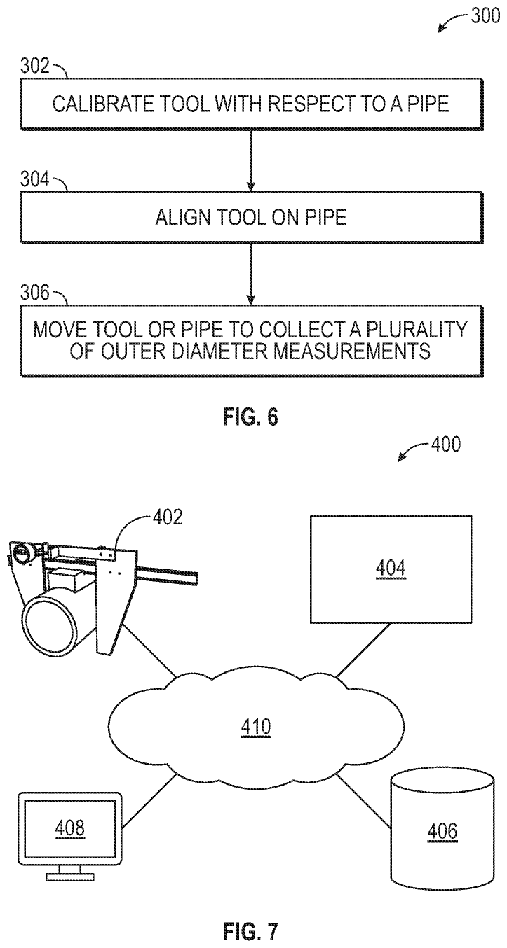

In use, a dimensional measurement tool of the present disclosure may be used to determine variation in a pipe's outer diameter by obtaining a plurality of outer diameter measurements. A tool of the present disclosure may be used to check outer diameter across a full length of the pipe, and around a full circumference of the pipe. The tool may be portable and may be may be manually wielded and positioned with relative ease. Moreover, an alignment shoe of the tool may allow for accurate positioning and measurement taking of the tool. Turning now to FIG. 6, a method 300 of using a dimensional measurement tool of the present disclosure is shown, according to at least one embodiment. As shown, the method 300 may include calibrating the tool with respect to a pipe 302; aligning the tool on the pipe 304; and moving the tool or pipe to collect a plurality of outer diameter measurements 306.

Prior to using the tool to obtain one or more outer diameter measurements of a pipe, the pipe may be calibrated for a particular pipe size. Calibrating the tool with respect to a pipe 302 may include positioning the tool on a calibration standard. The calibration standard may include a pipe, block, or other object having a known outer diameter or width. The calibration standard may have an outer diameter or width equal to an expected outer diameter of the pipe to be measured. For example, where a 5-inch pipe will be measured using the tool, the calibration standard may have a diameter or width of five inches. The tool may be arranged on the calibration standard such that the contact arms may be separated by the expected pipe diameter.

With the contact arms separated by the expected pipe diameter of the pipe to be measured, the gauge arm may be adjusted. In particular, the gauge arm may be adjusted to lengthen or shorten an extension of the gauge arm extending between the two contact arms. This may be performed by adjusting a position of the gauge arm where it couples to one of the contact arms, for example. It is to be appreciated that as an extension of the gauge arm between the contact arms is adjusted, the plunger of the plunger gauge may move as well. The gauge arm may be adjusted until the plunger is extended from the plunger gauge to half or approximately half of its extendable (or measurable) length. For example, where the plunger is configured to extend from the gauge to a length of 1 inch, such that the gauge may measure up to 1 inch, the gauge arm may be adjusted such that it holds the plunger at an extension of approximately 0.5 inches. The gauge arm may be fixed to hold the plunger in this configuration. The plunger gauge may then be zeroed or otherwise set or configured to measure variation (extension or retraction) from the plunger's current half-extension position.

The method 300 may additionally include aligning the measurement tool onto the pipe to be measured 304. Aligning the tool may include positioning the tool on the pipe with the alignment shoe arranged between the pipe and other components of the tool. For example, the alignment shoe may be arranged between an outer surface of the pipe and the track arm of the tool. The method 300 may further include moving the tool or the pipe to obtain a plurality of outer diameter measurements 306. In some embodiments, for example, the tool may be manually moved along the pipe length to obtain a plurality of outer diameter measurements along the longitudinal axis of the pipe and/or may be rotated about the pipe to obtain outer diameter measurements at a plurality of radial positions about the pipe. While the tool is maneuvered to different locations on the pipe length or circumference, the alignment shoe may maintain alignment of the contact arms. Additionally or alternatively, in some embodiments, the pipe itself may be moved with respect to the tool. For example, the tool may be held rotationally stationary, while the pipe is rotated about its longitudinal axis. In some embodiments, the pipe may be slid axially between the contact arms.

As the tool and/or pipe are moved to obtain a plurality of outer diameter measurements, the contact arms, which may be biased toward one another, may move toward and away from one another in response to variations in pipe diameter. As the contact arms move, the gauge arm, and thus the plunger, may move toward and away from the plunger gauge in response to variations in pipe diameter. The gauge may measure these variations from the expected outer diameter of the pipe. In this way, dimensional variation within the limits of the plunger gauge may be monitored across an entire outer surface of the pipe.

In some embodiments, the outer diameter variations determined by the plunger gauge may be recorded or logged. For example, the measurements may be communicated from the plunger gauge via a wired or wireless connection to a computing device, such as but not limited to a laptop computer, desktop computer, tablet computer, smartphone, or other suitable computing device. In some embodiments, the plunger gauge may have Bluetooth connectivity and may be configured to communicate the diameter measurements to a computing device via a Bluetooth connection. While the tool and/or pipe are moved to obtain the plurality of outer diameter measurements, measurements may be recorded or logged continuously, at intervals, intermittently, or on demand such as by user indication.

FIG. 7 shows a system 400 that may include a measurement tool 402, a processor 404, a data storage device 406, and a user interface 408 communicable coupled over one or more wired or wireless networks 410. The measurement tool 402 may be, or may be similar to, those discussed above, having a pair of contact arms configured to receive a pipe therebetween and a plunger gauge configured to extend or retract in response to a change in distance between the contact arms. In some embodiments, the processor 404, data storage device 406, and/or user interface 408 may be included in a single computing device, such as a laptop computer, desktop computer, tablet computer, smartphone, or other suitable computing device having a wired or wireless connection to the measurement tool 402. However, in other embodiments, the processor 404, data storage device 406, and/or user interface 408 may be provided as, or encompassed by, separate components or devices.

The processor 404 may include hardware and/or software configured to receive measurement data from the measurement tool 402. Measurement data may be received as plunger gauge readings in some embodiments. In particular, measurement data may be or include lengths of expansion or retraction of the plunger gauge from its calibrated reference point. Measurements may be collected and/or sent to the processor 404 continuously, intermittently, at intervals, or on demand such as by user initiation. In some embodiments, a user may indicate a “start” of when the tool 402 should begin sending measurement data to the processor 404 and a “stop” of when the tool should stop sending measurement data.

in some embodiments, the processor 404 may be configured to manipulate and/or evaluate the received measurement data. For example, where the data is received as plunger gauge depths or lengths, the processor 404 may be configured to convert the measurement data into outer diameter measurements. That is, for example, the processor 404 may add or subtract the plunger gauge measurements from the calibration standard size, at which the plunger gauge was zeroed, so as to present measurement data as outer diameter measurements. Additionally or alternatively, the processor 404 may be configured to evaluate the data to determine minimum, maximum, mean, median, or mode measurements and/or other suitable characteristics, statistical analyses, or representations of the data for a particular pipe, section of pipe, or group of pipes, for example. In some embodiments, the processor 404 may be configured to plot or chart the measurement data or to provide the measurement data in another suitable form. In some embodiments, the processor 404 may be configured to provide a polar chart or a three-dimensional model of a pipe or pipe section based on recorded measurements for the pipe. For example, a polar chart may be generated with the addition of a circumferential position encoder and suitable indexing marker. In some embodiments, with the further addition of an X-axis position encoder, or by simply adding together polar charts from known locations along the pipe, three dimensional models can be generated.

The data storage device 406 may include one or more local or remote data storage drives. The measurement data may be stored at the data storage device 406 on non-transferable computer readable storage media. The data may be stored as plunger gauge depth or length measurements, as diameter measurements, and/or in another suitable form.

The user interface 408 may be configured to provide user access to the measurement data. The user interface may be or include an application program interface and may be provided via a laptop computer, desktop computer, tablet computer, smartphone, or other suitable computing device. In some embodiments, the user interface 408 may be configured to be provided via a monitor, screen, or display. The user interface 408 may provide buttons, toggle switches, data fields, data menus, and/or other suitable mechanisms whereby a user may interact with the interface.

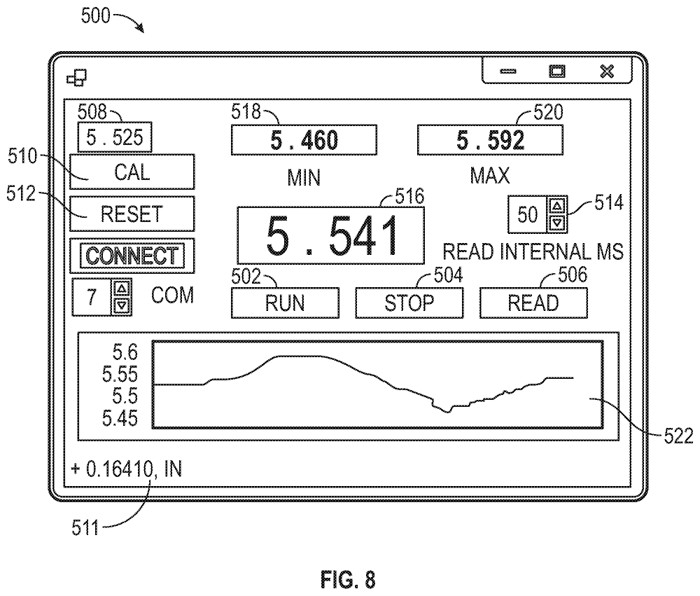

The user interface 408 may allow a user to view received measurement data and/or to initiate analyses or manipulations of the data. In some embodiments, the user interface 408 may allow a user to set one or more parameters for a pipe to be measured, to start and stop data measurement collection or logging, and/or to view measurement data. FIG. 8 shows one embodiment of a screen 500 that may be provided via the user interface 408 in one or more embodiments. In at least one embodiment, and as shown in FIG. 8, the interface may provide a “Run” button 502 whereby a user may initiate data collection. In particular, the user may initiate data collection prior to moving the measurement tool and/or pipe to collect a plurality of data measurements. A “Stop” button 504 may allow a user to stop data collection. A “Read” button 506 may allow a user to record discrete or individual data measurements. The screen 500 may display a calibrated diameter reading 508, which may be entered by a user. A “Calibrate” button 510 may allow a user to designate a calibration position of the plunger gauge. In particular, with the calibration standard arranged between the contact arms and the plunger extended to half, or approximately half, its extendable length, the user may indicate a calibration position by pressing the “Calibrate” button 510. In some embodiments, the plunger gauge position or depth at the calibration position may be recorded and/or displayed 511. A “Reset” button 512 may allow a user to reset parameters and/or recorded measurements. In some embodiments, a measurement interval setting 514 may allow a user to designate a frequency at which plunger gauge measurements should be recorded or logged. The screen 500 may display a current or most recent measurement 516, which may be a plunger gauge reading (e.g., depth or extended length) or may be a diameter measurement determined or calculated from the plunger gauge reading being added or subtracted from the calibrated reading 508 and/or calibrated plunger depth reading 511, for example. The screen 500 may additionally display a minimum 518 and maximum 520 measurement in some embodiments. The screen 500 may include a plot or graph 522 showing a plurality of measurements plotted along an X or Y axis. However, other plots or charts may be provided in other embodiments. It is to be appreciated that in other embodiments, the user interface may provide additional or alternative screens or displays having additional or alternative information and/or options.

The dimensional measurement tools disclosed herein, as well as the methods described above, may provide for a marked improvement over conventional techniques for determining an outside diameter profile of a pipe or conduit. For example, dimensional measurement tools of the present disclosure may provide for more accurate measurements than other handheld tools, such as calipers or micrometers. As disclosed above, the alignment shoe may align the tool with at least one, or at least two, axes of the pipe, which may allow a user to obtain more accurate measurements, as compared with other handheld devices. Additionally, the contact surfaces of the two contact arms may provide a relatively large contact surface area, as compared with micrometers or calipers. In some cases, micrometers and calipers have small points of contact with relatively small surface areas. Such small contact surfaces may lead to difficulties in aligning the tool and may ultimately lead to inaccurate measurements. In contrast, tools disclosed herein may have contact surfaces of at least 0.2, 0.3, 0.4, 0.5, or more inches in thickness. The relatively thick contact surfaces of the present disclosure may provide for more accurate alignment, and thus more accurate measurements.

The tools and methods disclosed herein may additionally provide for improvements over other measuring devices, such as laser devices. In particular, the dimensional measurement tool disclosed herein may be suitable for obtaining outer diameter measurements across an entire length, or substantially an entire length, of a pipe or conduit, whereas laser measurement device may not be configured to obtain measurements close to the ends of a pipe. Additionally, tools disclosed herein may be relatively inexpensive as compared with laser devices. Tools disclosed herein may additionally be more portable and may provide for faster setup and/or measurement, as compared with laser devices.

Moreover, tools disclosed herein may provide for improved adjustability or versatility as compared with conventional outside diameter measuring tools. For example, dimensional measurement tools disclosure herein may be configured for use with a wide range of pipe sizes (e.g. ranging from as small as 5 inches or smaller to as large as 16 inches or larger). To accommodate the different pipe sizes, different alignment shoes may be used in some embodiments, and may be changed out with relative ease. In contrast, some conventional measuring tools may not allow for measuring such a wide range of pipe sizes. Moreover, conventional tools such as calipers that are configured for measuring relatively large pipe diameters, such as 16 inches, may be large, heavy, and/or may be unwieldy or difficult to align on the pipe.

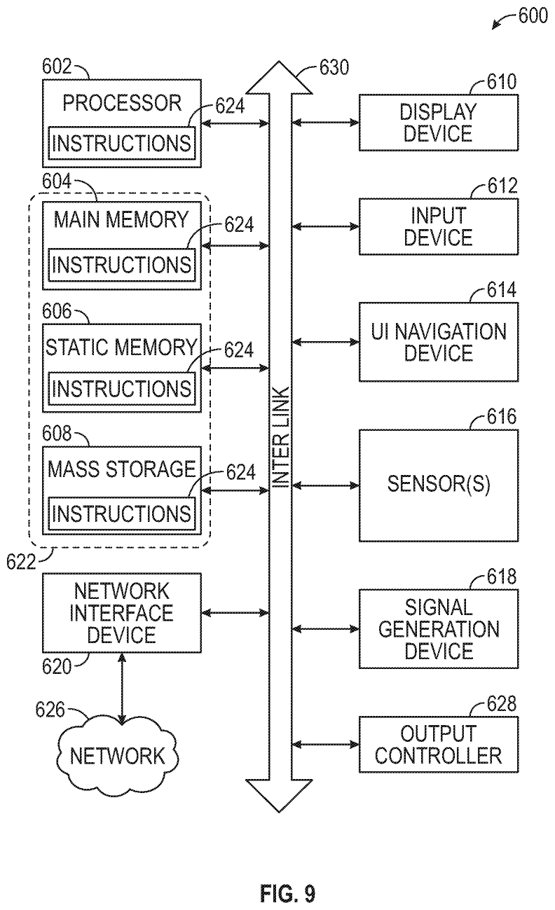

FIG. 9 illustrates a block diagram of an example machine 600 (which may be or be included as part of the system 400, processor 404, or other components described herein) upon which any one or more of the techniques (e.g., methods) discussed herein can perform. Examples, as described herein, can include, or can operate by, logic or a number of components, or mechanisms in the machine 600.

In some embodiments, the machine 600 can operate as a standalone device or can be connected (e.g., networked) to other machines. In a networked deployment, the machine 600 can operate in the capacity of a server machine, a client machine, or both in server-client network environments. In some examples, the machine 600 can act as a peer machine in peer-to-peer (P2P) (or other distributed) network environment. The machine 4000 can be a personal computer (PC), a tablet a set-top box (STB), a personal digital assistant (PDA), a mobile telephone, a smartphone, a personal fitness tracker, a smartwatch or other wearable device, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 600 can include a hardware processor 602 (e.g., a central processing unit (CPU), a graphics processing unit (GPU), a hardware processor core, or any combination thereof), a main memory 604, a static memory (e.g., memory or storage for firmware, microcode, a basic-input-output (BIOS), unified extensible firmware interface (UEFI), etc.) 606, and mass storage 608 (e.g., hard drives, tape drives, flash storage, or other block devices) some or all of which can communicate with each other via an interlink (e.g., bus) 630. The machine 600 can further include a display unit 610, an alphanumeric input device 612 (e.g., a keyboard), and a user interface (UI) navigation device 614 (e.g., a knob, dial, button, or mouse). In some examples, the display unit 610, input device 612 and UI navigation device 614 can be a touch screen display. The machine 600 can additionally include a storage device (e.g., drive unit) 608, a signal generation device 618 (e.g., a speaker), a network interface device 620, and one or more sensors 616, such as a global positioning system (GPS) sensor, compass, accelerometer, or other sensor. The machine 600 can include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 602, the main memory 604, the static memory 606, or the mass storage 608 can be, or include, a machine readable medium 622 on which is stored one or more sets of data structures or instructions 624 (e.g., software) embodying or utilized by any one or more of the techniques or functions described herein. The instructions 624 can also reside, completely or at least partially, within any of registers of the processor 602, the main memory 604, the static memory 606, or the mass storage 608 during execution thereof by the machine 600. In some examples, one or any combination of the hardware processor 602, the main memory 604, the static memory 606, or the mass storage 608 can constitute the machine readable media 622. While the machine readable medium 622 is illustrated as a single medium, the term “machine readable medium” can include a single medium or multiple media (e.g., a centralized or distributed database, and/or associated caches and servers) configured to store the one or more instructions 624.

The term “machine readable medium” (or “computer readable medium”) can include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples can include solid-state memories, optical media, magnetic media, and signals (e.g., radio frequency signals, other photon based signals, sound signals, etc.). In some examples, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media can include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In some examples, information stored or otherwise provided on the machine readable medium 622 can be representative of the instructions 624, such as instructions 624 themselves or a format from which the instructions 624 can be derived. This format from which the instructions 62.4 can be derived can include source code, encoded instructions (e.g., in compressed or encrypted form), packaged instructions (e.g., split into multiple packages), or the like. The information representative of the instructions 624 in the machine readable medium 622 can be processed by processing circuitry into the instructions to implement any of the operations discussed herein. For example, deriving the instructions 624 from the information (e.g., processing by the processing circuitry) can include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 624.

In some examples, the derivation of the instructions 624 can include assembly, compilation, or interpretation of the information (e.g., by the processing circuitry) to create the instructions 624 from some intermediate or preprocessed format provided by the machine readable medium 622. The information, when provided in multiple parts, can be combined, unpacked, and modified to create the instructions 624. For example, the information can be in multiple compressed source code packages (or object code, or binary executable code, etc.) on one or several remote servers. The source code packages can be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 624 can be further transmitted or received over a communications network 626 using a transmission medium via the network interface device 620 utilizing any one of a number of transfer protocols (e.g., frame relay, Internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In some examples, the network interface device 620 can include one or more physical jacks (e.g., Ethernet, coaxial, or phone jacks) or one or more antennas to connect to the communications network 626. In some examples, the network interface device 620 can include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software. A transmission medium is a machine readable medium.

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, middleware, microcode, hardware description languages, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. Computer-executable program code for carrying out operations of embodiments of the present disclosure may be written in an object oriented, scripted or unscripted programming language such as Java, Perl, PHP, Visual Basic, Smalltalk, C++, or the like. However, the computer program code for carrying out operations of embodiments of the present disclosure may also be written in conventional procedural programming languages, such as the C programming language or similar programming languages. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Various embodiments of the present disclosure may be described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the invention.

Additionally, although a flowchart or block diagram may illustrate a method as comprising sequential steps or a process as having a particular order of operations, many of the steps or operations in the flowchart(s) or block diagram(s) illustrated herein can be performed in parallel or concurrently, and the flowchart(s) or block diagram(s) should be read in the context of the various embodiments of the present disclosure. In addition, the order of the method steps or process operations illustrated in a flowchart or block diagram may be rearranged for some embodiments. Similarly, a method or process illustrated in a flow chart or block diagram could have additional steps or operations not included therein or fewer steps or operations than those shown. Moreover, a method step may correspond to a method, a function, a procedure, a subroutine, a subprogram, etc.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

Additionally, as used herein, the phrase “at least one of [X] and [Y],” where X and Y are different components that may be included in an embodiment of the present disclosure, means that the embodiment could include component X without component Y, the embodiment could include the component Y without component X, or the embodiment could include both components X and Y. Similarly, when used with respect to three or more components, such as “at least one of [X], [Y], and [7],” the phrase means that the embodiment could include any one of the three or more components, any combination or sub-combination of any of the components, or all of the components.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

What is claimed is:

1. A measurement tool for measuring an outer diameter of a pipe, the tool comprising:
a pair of contact arms configured to receive the pipe there between, each contact arm having a contact surface for engaging with an outer surface of the pipe;
a plunger gauge arranged on a first arm of the pair of contact arras, the plunger gauge having a plunger directed to extend toward a second of the pair of contact arms; and
an alignment shoe having a surface configured to engage with the outer surface of the pipe, the alignment shoe configured to stabilize a position of the contact arms with respect to the pipe.

2. The measurement tool of claim 1, further comprising a gauge arm arranged on the second arm of the pair of contact arms, the gauge arm having a plunger engaging portion configured to engage with the plunger.

3. The measurement tool of claim 1, wherein the pair of contact arms extend from a track arm.

4. The measurement tool of claim 3, wherein at least one of the contact arms slidingly engages the track arm.

5. The measurement tool of claim 3, wherein the alignment shoe is configured to engage with the track arm.

6. The measurement tool of claim 1, wherein the contact arms are biased toward one another.

7. The measurement tool of claim 2, wherein the gauge arm extends between the two contact arms with a length, and wherein the length is adjustable.

8. The measurement tool of claim 1, wherein the alignment shoe is configured to align the tool with an X-axis of the pipe and a Z-axis of the pipe.

9. The measurement tool of claim 1, wherein the contact surface of each contact arm has a thickness of at least 0.25 inches.

10. A method of determining variation in an outer diameter of a pipe using a measurement tool having a pair of contact arms configured to receive the pipe therebetween and a plunger gauge arranged on a first arm of the pair of contact arms, the method comprising:
calibrating the measurement tool by:
positioning a calibration standard between the two contact arms, the calibration standard having a known diameter or width; and
adjusting the tool such that a plunger of the plunger gauge is extended to approximately half of a full extension length of the plunger;
arranging the pipe between the two contact arms, together with an alignment shoe configured to align the tool, the alignment shoe having a surface configured to engage with an outer surface of the pipe; and
moving at least one of the measurement tool and the pipe to obtain a plurality of measurements along the outer surface of the pipe.

11. The method of claim 10, wherein a distance between the contact arms is configured to increase and decrease in response to variation in the outer diameter of the pipe.

12. The method of claim 11, wherein the contact arms are biased toward one another.

13. The method of claim 11, wherein the plunger of the plunger gauge is configured to extend and retract in response to variation in the outer diameter of the pipe.

14. The method of claim 10, wherein calibrating the measurement tool further comprises zeroing the plunger gauge.

15. The method of claim 10, wherein the tool comprises a gauge arm arranged on a second arm of the pair of contact arms and extending toward the first arm, and wherein adjusting the tool comprises adjusting a position of a gauge arm.

16. A system for measuring an outer diameter of a pipe, the system comprising:
a measurement tool comprising:
a pair of contact arms configured to receive the pipe there between, each contact arm having a contact surface for engaging with an outer surface of the pipe; and
a plunger gauge arranged on a first arm of the pair of contact arms, the plunger gauge having a plunger directed to extend toward a second of the pair of contact arms;
a processor in electronic communication with the measurement tool and configured to receive measurement data therefrom; and
a user interface configured to display the measurement data.

7. The system of claim 16, wherein the measurement data comprises one or more plunger gauge readings, and wherein the processor is further configured to convert the one or more plunger gauge readings into one or more diameter measurements based on a stored calibration standard.

18. The system of claim 16, wherein the processor is further configured to perform one or more statistical analyses of the measurement data.

19. The system of claim 18, wherein the user interface is configured to display the one or more statistical analyses.

20. The system of claim 16, further comprising a database for storing the measurement data.
